(19) United States
(12) Patent Application Publication
(10) Pub. No.: US 2014/0268507 A1
(43) Pub. Date: Sep. 18, 2014

(54) Cable Protector for Utility Meter

(71) Applicant: ITRON, INC, Liberty Lake, WA (US)

(72) Inventor: Todd Arthur Cannon, Mantorville, MN (US)

(73) Assignee: ITRON, INC., Liberty Lake, WA (US)

(21) Appl. No.: 13/839,714

(22) Filed: Mar. 15, 2013

(51) Int. Cl. H01B 7/18; H01B 19/00

(52) U.S. Cl. CPC H01B 7/1855; H01B 19/00
USPC 361/668; 174/136; 29/592.1

(57) ABSTRACT

Techniques for the construction and use of cable protectors are described herein. The cable protectors may be used to protect cables in a wide variety of applications, locations and environments, including a utility (e.g., water or gas) metering application. In one example, the cable protector may protect a cable connecting a water meter to a radio. The cable protector may be constructed of a ribbon of durable material (e.g., stainless steel) configured as a helix. The helix may define a central channel through which the cable may pass. The cable protector may have spacing between adjacent turns of the helix that are too narrow to allow attack of the cable by animals. Exact dimensions may depend largely on a size of a cable to protect, and an environment and use of the cable.

### BACKGROUND

Cables that are exposed to the environment are frequently damaged by animals, particularly rodents. The damage results when such animals gnaw on the soft electrical insulation present on most cables and damage the wiring within the cable.

Cables that are used with residential and/or commercial water meters are often particularly vulnerable to rodent attack. Such cables may be located in partially enclosed boxes, which may be partially buried in the ground. Such enclosures may attract rodents, due to the protection from weather and elements they offer.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components. Moreover, the figures are intended to illustrate general concepts, and not to indicate required and/or necessary elements.

FIG. 1 is a cross-sectional view of an enclosed water meter and radio, showing a cable between the two units having an example cable protector.

FIG. 2 is a view of a water meter and a radio, connected by a cable having an in-line connector. Sections of the cable on both sides of the in-line connector are protected by cable protectors.

FIG. 3 is a diagram showing an example of a cable protector installed on a cable.

FIG. 4 is a diagram showing an enlarged view of the example cable protector.

FIG. 5 is a flow diagram showing an example method by which a cable protector may be utilized.

### DETAILED DESCRIPTION

### Overview

The disclosure describes a cable protector that may be utilized to protect cables used in a wide variety of applications, locations and environments. In one example application, the cable protector may be used in a utility (e.g., water or gas) metering application. The cable protector may protect a cable connecting a water meter to a radio. The water meter and radio may be located in an enclosure that is fully or partially buried in the ground. While some such enclosures may be breached by rodents, the cable protector will provide effective protection of the cable inside the enclosure.

In one example, the cable protector may be constructed of a ribbon of metal (e.g., stainless steel) configured as a helix. The helix may define a central channel through which the cable may pass. The helix may be right-handed, to advance in response to clockwise revolution. The ribbon may be about 0.002 to about 0.01 inches thick. The edges of the ribbon may be rounded or simply deburred. In one specific application, the cable protector may have spacing between adjacent turns of the helix of approximately 0.05 inches, a center-to-center distance between adjacent turns of the helix of approximately 0.24 inches and an inside diameter of the helix of approximately 0.19 inches. The exact dimensions of a cable protector may depend largely on a size of a cable to protect, and an environment and/or use of the cable.

### Example Cable Protector in Example Water Meter Installation

FIG. 1 shows a cross-sectional view an example environment 100 within which a cable protector may be beneficially utilized. The example environment 100 may be a utility metering environment, and may include a water or gas meter at a residential or commercial location. In the example shown, a water meter 102 is in wired communication with a radio 104. The environment may include an enclosure 106, typically having at least four sides and a top. While such an enclosure 106 may provide protection from the elements for the enclosed metering equipment, the protective environment of enclosure may actually attract rodents or other animals.

In the example shown, a cable connecting the water meter 102 and the radio 104 is protected by a cable protector 108. The cable protector 108 protects the cable from rodents and other vermin, particularly when the rodents gain access or entry to the enclosure 106.

FIG. 2 shows an example system 200, including a water meter 102 and a radio 104. In this example, cables extending from each of the water meter 102 and radio 104 are joined by an in-line connector 202. Two cables attached to the in-line connector 202 are protected by cable protectors 204, 206.

### Example Cable Protector Structural Detail

FIG. 3 is a diagram showing an example section 300 of a cable protector installed on a cable 302. The example section 300 of cable protector may be constructed of a ribbon of stainless steel or other material configured as a helix. The helix may be either right-handed or left-handed, although a right-handed helix will lead to expected results if a technician twists the cable protector onto a cable in a clockwise manner during an installation process. That is, a technician who bends or extends the end of the helix over a cable and begins to twist the cable protector onto the cable would expect to rotate the cable protector in a clockwise manner. Spacing between adjacent turns of the helix is typically at a regular or consistent distance. In particular, the spacing may be sized to allow bending of the ribbon. Additionally, the spacing may be sized to prevent access to the cable 300 by one or more different types of pest, such as rodents or other vermin. A channel 304 may be defined within the interior of the helix of the cable protector and may be sized to accommodate a desired cable and/or cable diameter. In particular, the channel 304 may have an inside diameter that is equal to or greater than an outside diameter of the cable to be protected.

FIG. 4 is a diagram showing an enlarged view of the example cable protector 300. The cable protector may be made of a ribbon of durable material (e.g., stainless steel, carbon steel, aluminum, titanium, etc.) having an appropriate width and an appropriate thickness indicated by circumstances of a particular application. In some applications, the material used could be selected due to magnetic properties or the lack thereof. In one very specific example, the width may be about 0.19 inches and the thickness may be about 0.005 inches. Other examples could vary considerably.

The cable protector 300 may be configured as a helix having turns that define a spacing that is consistent with several factors. Among the factors that may be considered when specifying spacing between turns of the helix include: the ability of particular rodents to reach through gaps of particular sizes; the need for the cable protector to be flexible and/or bendable; and the need to not pinch or bind the cable and/or insulation. In particular, the spacing may be selected to prevent a rodent from reaching through the spacing and chewing the cable protected within the channel.

In the example shown, adjacent turns 400 of the helix are separated by a spacing 402 of at least about 0.03 and at most about 0.07 inches. In one example, the spacing may be approximately 0.05 inches. However, the spacing 402 is not required to be within this range, and may be set based on a particular cable to be protected, required cable flexibility and/or the perceived source of the threat or hazard, etc.

In other examples, the ribbon forming the helix may have a thickness of at least about 0.002 and at most about 0.01 inches. However, the thickness is not required to be within this range and may depend somewhat on the material used to make the ribbon, the use to which the cable protector is put, the threats to the cable and other factors.

In the example shown, the center-to-center distance 404 between the about 0.24 inches. In another example, the center-to-center distance between the adjacent turns is at least about 0.15 and at most about 0.3 inches. However, the center-to-center distance 404 is not required to be within this range, and may be set based on a particular cable to be protected, a particular environment of use and a particular rodent, threat or hazard, etc.

Also in the example shown, an inside diameter 406 of the helix may be approximately 0.19 inches. In another example, the inside diameter may be between about 0.12 and at most about 0.3 inches. However, the inside diameter 406 is not required to be within this range, and may be set based on a diameter of a particular cable to be protected, whether the cable is to be installed in the factory or in the field and/or other factors.

The edges of the cable may be rounded or deburred. For example, a #1 round edge may be used. Alternatively, a #5 deburred edge may be used. In some instances, the end of the cable may be hemmed.

In one further example, the helix may have a center-to-center distance between adjacent turns that is approximately three to six times greater than a spacing between the adjacent turns. A channel defined within the helix may have a diameter that may be more or less than the center-to-center distance between the adjacent turns. However, the ratio between these measurements is not a critical factor.

### Example Methods of Cable Protector Utilization

FIG. 5 is a flow diagram showing an example method 500 by which a cable protector may be utilized. In an overview, a properly sized cable protector, which may be configured at least in part based on the examples of FIGS. 1-4, may be installed on any desired cable for use in a variety of environments, as indicated by product and/or project design requirements.

At operation 502, a length of cable protector may be cut to a length sized to a length of a cable to be protected. In the example of a utility meter environment, the length of cable protector may be cut to a length of a cable connecting a radio unit and a metering unit. In the context of the example of FIG. 1, the cable protector 108 is cut to a length of a cable connecting the water meter 102 and radio 104 (e.g., an encoder receiver/transmitter). In the context of the example of FIG. 2, the cable protectors 204, 206 are cut to lengths indicated by the cables on either side of the in-line connector 202. In the context of a general example, a length of cable protector is cut to a length indicated by a cable to be protected.

At operation 504, the cut length of cable protector is installed over a free end of the cable. The “free end” is an end that is not connected to something (e.g., a water meter) that would prevent the installation. The installation may be performed in “the field,” e.g., at a utility customer's site. In such an environment, the service technician may be required to cut a segment of cable protector from a spool and/or size cable protector lengths in an approximate manner. The installation may also be performed by factory technicians in a relatively precise environment, wherein component dimensions (e.g., cable and cable protector dimensions) are closely controlled.

At operation 506, the cut length of cable protector is installed by twisting and advancing the cable protector onto the cable. In the example of operation 506, the installation may be performed in the field by a technician. In some instances, the technician does not have to disconnect the cable to be protected. The technician may slightly bend one curved end of the helix of the cable protector to extend and hook that end onto the cable. At that point, rotation of the cable protector will, turn-by-turn, result in wrapping of the cable protector about the cable to be protected. In particular, if the ribbon of the cable protector is configured as a right-handed helix, clockwise rotation of the cable protector will assist in advancing the cable protector over the cable.

At operation 508, the cut length of cable protector is installed by sliding the cable protector onto the cable without rotation. In the example of operation 508, the installation may be performed in a factory setting, such as by factory workers and/or machinery.

At operation 510, the cable may be secured with the cable protector in place, protecting the cable. In one example related to the utility industry, the cable may be secured between a radio unit and a metering unit, or one or more in-line connectors, etc.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims

What is claimed is:

1. A cable protector, comprising:
a ribbon configured as a helix defining spacing between adjacent turns of the ribbon, the spacing sized to allow bending of the cable protector and to prevent rodent access; and
a channel defined within the interior of the helix and sized to accommodate a cable.

2. The cable protector of claim 1, wherein the helix is right-handed.

3. The cable protector of claim 1, wherein the ribbon is made of stainless steel.

4. The cable protector of claim 1, wherein edges of the ribbon are rounded.

5. The cable protector of claim 1, wherein edges of the ribbon are deburred.

6. The cable protector of claim 1, wherein the ribbon is at least about 0.002 and at most about 0.01 inches thick.

7. The cable protector of claim 1, wherein the spacing between adjacent turns of the helix is at least about 0.03 and at most about 0.07 inches.

8. The cable protector of claim 1, wherein center-to-center distance between the adjacent turns is at least about 0.15 and at most about 0.3 inches.

9. The cable protector of claim 1, wherein:
spacing between the adjacent turns of the helix is approximately 0.05 inches; and
center-to-center distance between the adjacent turns is approximately 0.24 inches; and
an inside diameter of the helix is approximately 0.19 inches.

10. A cable protector, comprising:
a helix having a center-to-center distance between adjacent turns that is at least about three times and at most about six times greater than a spacing between the adjacent turns; and
a channel defined within the helix having a diameter that is less than the center-to-center distance between the adjacent turns.

11. The cable protector of claim 10, wherein:
the helix is right-handed; and
the cable protector is made of stainless steel.

12. The cable protector of claim 10, wherein edges of a ribbon forming the helix are deburred or rounded.

13. The cable protector of claim 10, wherein a ribbon forming the helix is at least about 0.002 and at most about 0.01 inches thick.

14. The cable protector of claim 10, wherein the spacing between adjacent turns of the helix is at least about 0.03 and at most about 0.07 inches.

15. The cable protector of claim 10, wherein:
the spacing between the adjacent turns of the helix is approximately 0.05 inches; and
a center-to-center distance between adjacent turns is approximately 0.24 inches; and
an inside diameter of the helix is approximately 0.19 inches.

16. A utility meter, comprising:
a metering unit;
a radio unit, connected to the metering unit by a cable; and
the cable protector of claim 10, installed to protect the cable.

17. A utility meter, comprising:
a metering unit;
a radio unit, connected to the metering unit by a cable having an in-line connector; and
a segment of the cable protector of claim 10 installed on the cable on each side of the in-line connector.

18. A method of protecting a cable in a utility meter, comprising:
cutting a length of cable protector to a length indicated by a length of the cable in the utility meter connecting a radio unit and a metering unit; and
installing the cut length of cable protector over a free end of the cable.

19. The method of claim 18, wherein:
the cable protector is configured as a right-handed helix; and
installing the cut length of cable protector comprises twisting the cable protector in a clockwise direction.

20. The method of claim 18, wherein:
an inside diameter of the cable protector is greater than an outside diameter of the cable; and
installing the cut length of cable protector comprises sliding the cable protector onto the cable without rotation.
